(19) United States
(12) Patent Application Publication
(10) Pub. No.: US 2011/0175370 A1
(43) Pub. Date: Jul. 21, 2011

(54) Portable Multi-Stack Flywheel Energy Storage Assembly

(76) Inventor: Patrick J. Dugas, Winter Haven, FL (US)

(21) Appl. No.: 12/690,397

(22) Filed: Jan. 20, 2010

(51) Int. Cl. F03G 3/08; H02K 7/02

(52) U.S. Cl. 290/1 R; 318/161

(57) ABSTRACT

The Portable Multi-stack Flywheel Energy Storage Assembly stores energy from any electrical grid or other energy source such as wind turbines and photovoltaic solar power to a flywheel assembly. The invention is comprised of a motor/generator with a combination of multi-stacked flywheels, positive locking roller stops and speed activated clutches. The preferred embodiment would utilize variable inertia flywheels that has a liquid chamber which can be filled after assembly allowing greater portability than conventional flywheels. The rotating liquid provides the mass that spins up with less initial energy, requires lower operating speed for greater safety and reduced cost, and can be drained to move to another location if desired. When the power source is removed from the motor, the spinning flywheels cause the motor/generator to function in its generator mode, thereby supplying needed electrical energy back into the system.

### TECHNICAL FIELD

This invention relates to mechanical energy storage devices that store energy from any electrical grid or other energy source such as wind turbines and photovoltaic solar power to a flywheel assembly.

### BACKGROUND OF THE INVENTION

Flywheels and batteries have been used to store energy from power sources for many years. Existing flywheel technology consists of a heavy rotating disc that is accelerated to high speeds by an electric motor. Electricity is stored as kinetic energy of the rotating flywheel. Friction must be kept to a minimum to prolong the storage time; it is often achieved by placing the flywheel in a vacuum, using magnetic bearings, which tends to make the method expensive. The high speeds needed in conventional flywheels present safety issues. Batteries are generally expensive, high maintenance, heavy, have limited lifespan and are environmentally harmful.

### SUMMARY OF THE INVENTION

The Portable Multi-stack Flywheel Energy Storage Assembly (PMFESA) has enhanced efficiency compared to a conventional flywheel system. The PMFESA is portable, lightweight, operates at lower, safer speeds and can be individually stacked as needed to meet various demand requirements. The present invention stores energy during high productions or low demands, then selectively releases the energy when needed through a motor/generator. The invention is comprised of a motor/generator with a combination of multi-stacked flywheels, positive locking roller stops and speed activated clutches. The preferred embodiment would utilize variable inertia flywheels that has a liquid chamber which can be filled after assembly allowing greater portability than conventional flywheels. The rotating liquid allows a portion of the mass to spin up slower than the solid components so that the mass spins up with less initial energy, requires lower operating speed for greater safety and reduced cost, and can be drained to move to another location if desired. Variable inertia flywheels are used where energy input is not constant, and can capture very small increments of energy as well as being able to absorb and capture massive bursts of energy.

### BRIEF DESCRIPTION OF THE DRAWINGS

FIG. 1 is a lateral view through the center of the shaft of the assembly for a vertical axis configuration showing the sequencing of the components.

FIG. 2A and FIG. 2B are sectional views along lines A-A and B-B respectively showing the method of attaching the portable stacks of components.

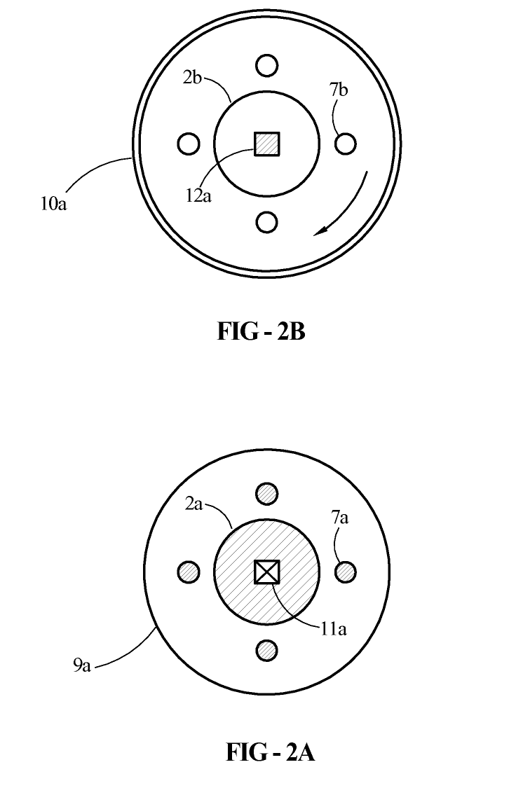

### DETAILED DESCRIPTION OF THE PREFERRED EMBODIMENTS

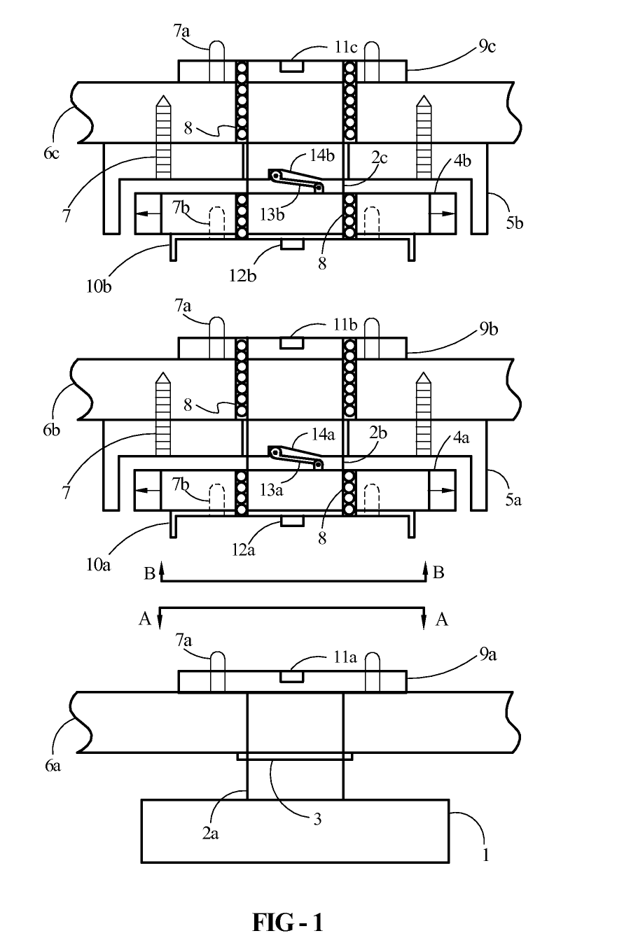

As shown in the figures, the PMFESA of the present invention is a sequence of various components to store energy from various sources of electrical power (i.e. electrical grid, wind turbine, solar collector etc.) through a motor/generator and rotating shaft into a series of flywheels. The PMFESA assembly in FIG. 1 is comprised of a motor/generator 1 turning shaft 2a. Collar 3 attaches the first variable inertia flywheel (patent application Ser. No. 11/833,611) 6a to shaft 2a. When shaft 2a rotates, the containment portion of the first variable inertia flywheel 6a rotates at the same speed. The liquid portion of the variable inertia flywheel reaches the same speed over time. The preferred embodiment may use a Containment Reinforced Variable Inertia Flywheel (patent application Ser. No. 12/548,107)

When another flywheel assembly is stacked on, notch 11a (female) in shaft 2a and spacer 9a engage with the key 12a (male) on shaft 2b and containment connector 10a on bearings 8. Pins 7a in spacer 9a engage with holes 7b in connector 10a. Set screws or other desired fasteners through 10a into 9a may be used to secure the assembly after stacking. Shaft 2a is connected to the internal expending part 4a of a speed-activated clutch on which the spring arms 13a of a positive locking roller stop (patent application Ser. No. 12/503,053) are attached. When shaft 2b reaches a desired rotational speed, the internal expending part of the speed activated clutch on disk 4a engages the outer drum part 5a of the speed activated clutch which is fastened to the second flywheel 6b with fasteners 7. Flywheel 6b rotates on shaft 2b with bearings 8. The drum body 5a of the speed-activated clutch incorporates the positive locking grooves 14a of the positive locking roller stop (PLRS). The PLRS allows flywheel 6b to engage and lock on to shaft 2b when its rotational speed is greater than the speed of shaft 2b due to a decrease in electrical energy input to the motor/generator 1.

This sequence is shown again for variable inertia flywheel 6c, speed activated clutch/PLRS 4b/5b and can continue for a plurality of desired combinations. Alternately, if optimum portability is not desired, the components may be attached with spacers on a continuous shaft in lieu of the male/female, containment connectors 12a/11a and 9a/10a. Also the flywheels may be solid in lieu of variable inertia type with a liquid chamber.

What is claimed is:

1. A Portable Multi-Stack Flywheel Energy Storage Assembly comprising:
A motor generator
One solid shaft or alternatively
One or more notched shafts
One or more keyed shafts
A plurality of flywheels
A plurality of speed activated clutches
A plurality of positive locking roller stops
One or more containment connectors
One or more collars

2. Portable Multi-Stack Flywheel Energy Storage Assembly of claim 1 wherein a motor generator turns shaft to provide a turning motion.

3. Portable Multi-Stack Flywheel Energy Storage Assembly of claim 1 wherein one or more shafts allow a plurality of flywheels to rotate, starting up sequentially after each preceding flywheel reaches a predetermined speed

4. Portable Multi-Stack Flywheel Energy Storage Assembly of claim 1 wherein the shaft allows one or more flywheels rotation to begin sequentially.

5. Portable Multi-Stack Flywheel Energy Storage Assembly of claim 1 wherein the collar attaches one flywheel to the shaft.

6. Portable Multi-Stack Flywheel Energy Storage Assembly of claim 1 to include positive locking roller stops for rotation in one direction.

7. Portable Multi-Stack Flywheel Energy Storage Assembly of claim 1 wherein one or more flywheels engage when its rotation is greater than the shafts rotation.

8. Portable Multi-Stack Flywheel Energy Storage Assembly of claim 1 wherein a notched shaft allows the flywheel assembly to stack onto another flywheel assembly that is engaged with a keyed shaft.

9. Portable Multi-Stack Flywheel Energy Storage Assembly of claim 1 wherein the containment connectors help secure the flywheel assembly into a keyed shaft.

10. Portable Multi-Stack Flywheel Energy Storage Assembly of claim 1 wherein a speed activated clutch engages when a preceding flywheel reaches a desired rotational speed.

11. A means to accumulate and store excess electrical energy in very small to very large increments, store and release as needed.

12. A method to accumulate and store excess electrical energy in very small to very large increments, store and release as needed.
